(19) United States
(12) Patent Application Publication
(10) Pub. No.: US 2018/0008499 A1
(43) Pub. Date: Jan. 11, 2018

(54) ORTHOPEDIC DEVICE AND METHOD FOR LOWER LIMB ELEVATION AND STABILIZATION

(71) Applicant: BONE FOAM, INC., Corcoran, MN (US)

(72) Inventors: Stephen Davis Lucey, Greensboro, NC (US); Chad L. Robran, Plymouth, MN (US)

(21) Appl. No.: 15/676,643

(22) Filed: Aug. 14, 2017

Related U.S. Application Data
(63) Continuation-in-part of application No. 14/709,630, filed on May 12, 2015.

(51) Int. Cl. A61G 13/12; A61G 13/10

(52) U.S. Cl. CPC A61G 13/125; A61G 13/10

(57) ABSTRACT

In the context of medical recovery from injury and/or surgery to a lower extremity, a device may be used to provide elevation and support for a patient's foot, including ankle and heal, along with restraint against rotation of the lower leg of a patient. This can protect the knee from injury. The device may include a generally flat main body, two spaced-apart lateral ridges extending along or near lateral edges of the generally flat main body, and a medial depression between the lateral ridges that provides a support surface on which the ankle may be positioned.

### CROSS REFERENCE TO RELATED APPLICATION

This Application is a continuation-in-part of U.S. patent application No. 14/709,630, filed May 12, 2015, the disclosure of which is incorporated by reference in its entirety.

### BACKGROUND

Following injury or a lower limb surgical procedure, a patient often lies or is placed in a supine position, i.e. with the front (anterior) portion of the lower limb facing up and the back portion of the lower limb (posterior) facing downward. As part of the recovery, it is often required that the lower limb remain in a certain position, being isolated, immobilized, and elevated, for a period of time.

Many kinds of undesirable movements are possible, however, during this time period of recovery. For example, natural movement may arise as the patient's foot naturally tends to rotate outwardly, which can exert torsion on an injured or newly repaired knee. Other movements may also be readily ascertained.

### BRIEF SUMMARY

In the context of medical recovery of extremity trauma, efforts may be taken to ensure that a patient's body is properly elevated, isolated, stabilized, and/or otherwise supported. The patient may lie, for example, in a supine position, with the ankle required to be isolated, elevated, immobilized, and supported. Furthermore, the natural inclination of the foot to rotate outwardly or inwardly due to relaxation or gravity may in turn cause the tibia and fibula to rotate relative to the femur. This in turn may cause unwanted and potentially dangerous torsion or torque to the knee joint. For example, a patient recovering from knee surgery may incur serious pain, reinjure the knee, and even require additional surgery if the knee is not properly protected from torsion. Thus, the foot may be required to be restricted from external rotation, or rotating laterally, away from the body to protect the knee.

A support device as disclosed herein may be used to isolate, elevate, immobilize and support an ankle to provide restraint against foot and lower leg rotation. The patient may lie, for example, in a supine position, with the foot, including ankle and heel, resting on or in the support device. The support device may include a main body with a generally flat lower surface, two spaced-apart lateral ridges extending upwardly along or near lateral edges of the main body, and a medial depression between the lateral ridges that provides a support surface on which the foot may be positioned. The lateral ridges can restrain the foot from medial and lateral rotation. The support device may further comprise a medial ridge connected to the lateral ridges. The support device can terminate at a location proximal to the ankle and distal to the calf muscle so that the calf muscle and region behind the knee are not in contact with the support device. This assists in maintaining the knee in an extended position.

### BRIEF DESCRIPTION OF THE DRAWINGS

FIG. 1 is a perspective view of a device for lower limb elevation and foot immobilization to prevent rotation.

FIG. 2 is a top view of the device of FIG. 1 for lower limb elevation and foot immobilization to prevent rotation.

FIG. 3A is a perspective view of a foot inserted into the device of FIG. 1 for lower limb elevation and foot immobilization to prevent rotation.

FIG. 3B is an end view of the device of FIG. 3A with a foot inserted into the device for lower limb elevation and foot immobilization to prevent rotation.

FIG. 3C is an alternative perspective view of the device of FIG. 3A with a foot inserted into a device for lower limb elevation and foot immobilization to prevent rotation.

FIG. 4 is a perspective view of an embodiment of a device including a medial ridge for lower limb elevation and foot immobilization to prevent rotation.

FIG. 5 is a front view of the device of FIG. 4 for lower limb elevation and foot immobilization, the device including a medial ridge.

FIG. 6A is a perspective view of a foot inserted into the device of FIG. 4 for lower limb elevation and foot immobilization, the device including a medial ridge.

FIG. 6B is an end view of the device of FIG. 6A with a foot inserted into a device for lower limb elevation and foot immobilization, the device including a medial ridge.

### DETAILED DESCRIPTION

For lower limb medical recovery, such as following knee surgery or injury, a patient often lies or is placed in a supine position, i.e. with the front (anterior) portion of the lower limb facing up and the back portion of the lower limb (posterior) facing down. As part of the recovery, it is often required for the lower limb to remain in a certain or fixed position, being isolated and elevated, for a period of time. Also, elevating the lower leg from the bed surface may be desirable to ensure proper blood flow for reduction of edema and promotion of healing. Other benefits from elevating the leg may be realized. Rotation of the foot may cause detrimental rotation of the lower leg. The twisting or torsioning effect on the leg may slow the process of healing, cause pain, and even further injury to the knee joint following knee injury or surgery. Thus, support devices are needed to elevate lower limbs and immobilize the foot and ankle to ensure proper positioning and proper healing.

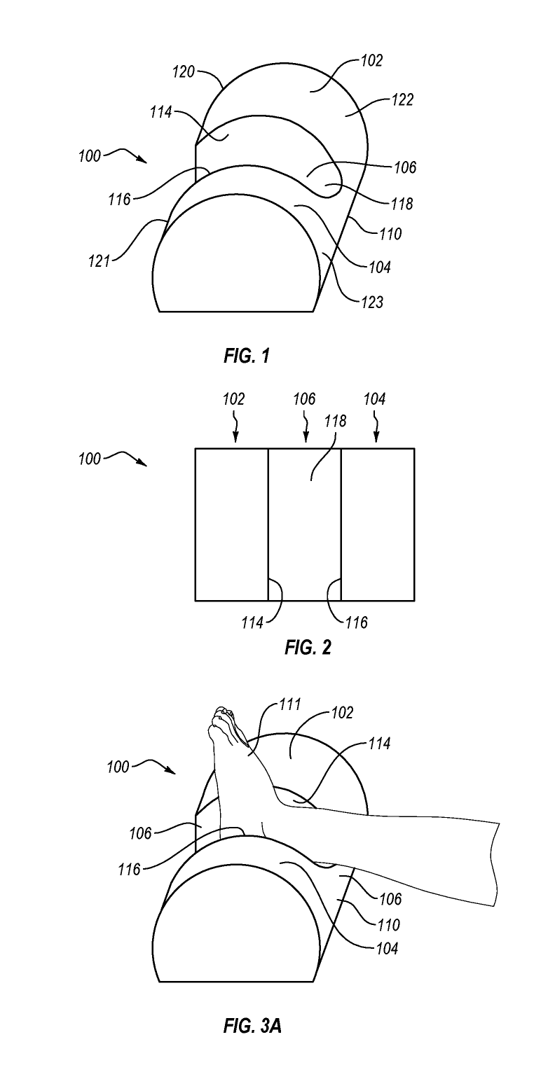

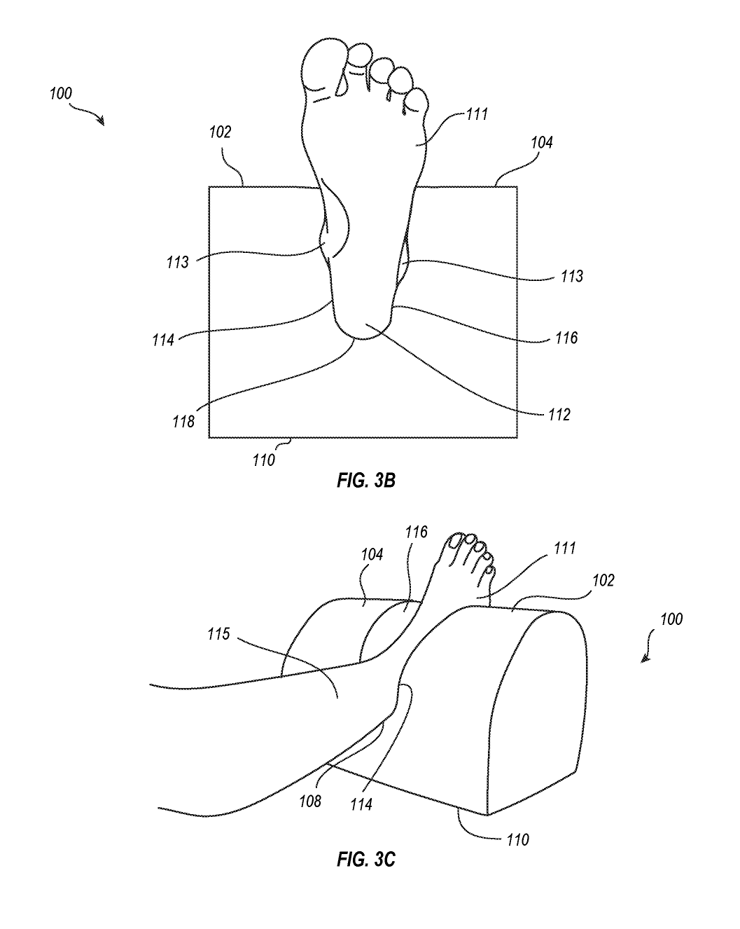

FIG. 1 is a perspective view illustrating a support device 100 for lower limb elevation and stabilization. The support device 100 may comprise a main body 110 having a generally flat bottom surface, two spaced-apart lateral ridges 102 and 104 extending upwardly away from main body 110 along or near lateral edges of main body 110, and a medial depression 106 between lateral ridges 102 and 104 that provides a support surface 118 on which a foot, including ankle 113 and heel 112 (FIG. 3B), of a patient may be positioned. Lateral ridges 102 and 104 may include inner side surfaces 114 and 116 extending upward from support surface 118 and that can contact the foot and restrain medial and/or lateral rotation of the patient's foot. Lateral ridges 102 and 104 further include distal upper surfaces 120 and 121 and proximal upper surfaces 122 and 123.

From main body 110 with generally flat bottom surface, lateral ridges 102 and 104 extend generally vertically upward and are located near or at along sides of main body 110. Lateral ridges 102 and 104 may span a desired distance along the width of main body 110, or span an entire side of main body 110. In some embodiments, lateral ridges 102 and 104 have lengths that extend beyond one or more main body edges, creating an overhang wall formation.

FIG. 2 is a top view of support device 100, with main body 110, lateral ridges 102 and 104, medial depression 106 seen from above. As illustrated, main body 110 may include a generally rectangular body. Alternatively, the shape of main body 110 may be multi-sided with sharp or rounded corners, such as rectangular, trapezoidal, or rectilinear, oblong, oval, circular, or have other shapes, proportions, and dimensions. The length may be larger than the width or, alternatively, the width may be larger than the length. Edges may be defined with sharp edges, curved edges, or a combination thereof.

The width, or wall thickness, of lateral ridges 102 and 104 may be the same or they may vary. Although the widths of lateral ridges 102 and 104 are shown as being homogeneous in spanning main body 110 in a parallel manner, the widths may have varying dimensions such that one or more of inner side surfaces 114 and 116 extends in a path that is not truly crosswise. For example, the widths of inner side surfaces 114 and 116 may be narrowed or tapered inwardly near or at a region where the ankle 113 and heel 112 would be located on support surface 118 (FIG. 3B). Alternatively, the widths of inner side surfaces 114 and 116 may be tapered outward from a center region where the ankle 113 and heel 112 would be located on support surface 118.

Support surface 118 in medial depression 106 may be contoured to conform to one or more of the lower leg distal to the calf, heel, ankle region, and talus of the patient. To conform to the lower leg, heel, ankle region, and talus of the patient, inner side surfaces 114 and 116 may have notches, or hollowed out cavities, removed near or at the center area where the ankle and heel are located on support surface 118 when placed in depression 106. Alternatively, a vertical hollowed out indention in each inner side surface 114 and 116 of lateral ridges 102 and 104 may be provided, forming a vertical hollow on each inner side surface 114 and 116. Providing a hollowed section, whether it be a cavity or vertical hollow, on each inner side surface 114 and 116 allows the support device 100 to be used for either a left foot or right foot.

Support surface 118 of medial depression 106 may be generally flat; however, embodiments include a variety of different surfaces, including a surface that is curved, rounded, wavy, concave, convex, slanted upward, curved upward, slanted downward, curved downward, as well as a variety of other surfaces. In some embodiments, support surface 118 is curved and slanted upward or downward, providing a curving slope that better conforms to the heel and ankle when the foot is placed in depression 106. In some embodiments, there may be a second depression within depression 106 providing support surface 118. This permits a heel of a foot to be sunken into the second depression below the level of depression 106, thereby providing a support surface 118 with a first upper level supporting the ankle and a second lower level supporting the heel. This may help to further isolate the heel from movement and thereby further restrain leg, foot, and ankle rotation (medial and/or lateral), as well as allowing the support surface 118 in the depression 106 to comfortably support the natural contours of the ankle and heel.

In some embodiments, at least a portion of a distal upper surface of one of the spaced-apart lateral ridges 102 and 104 can have a downward slope declining towards a proximal end. As shown, both distal upper surfaces 120 and 121 have downward slopes. In other embodiments, only one distal upper surface may have a downward slope.

In some embodiments, at least a portion of a proximal upper surface of one of the spaced-apart lateral ridges 102 and 104 can have a downward slope declining towards a proximal end. As shown, both proximal upper surfaces 122 and 123 have downward slopes; however, in some embodiments, only one proximal upper surface may have a downward slope.

The downward slope may be a curved, or rounded, downward slope. The combined proximal upper surfaces 122 and 123 and distal upper surfaces 120 and 121 may form an upside down cupping shape. Any suitable shape may be provided however. For example, instead of a curved shape, the combined upper surfaces may be generally flat, creating a standard wall appearance.

Outer edges of the proximal upper surfaces 122 and 123 and distal upper surfaces 120 and 121 may be sharp, blunt, or be rounded and smoothed out. For height, lateral ridges 102 and 104 may have the same or similar height; however, their heights may differ. Also, there may be differences in curvatures and edges, shapes, length, and width.

One or both of lateral ridges 102 and 104 may extend generally vertically upward to a height of at least a general foot length according to anatomical measurements of a standard person. In this way, inner side surfaces 114 and 116 of lateral ridges 102 and 104 can abut the sides of a patient's foot 111 and thereby restrain medial and/or lateral rotation. A standard person is a mathematical model of a person based on any suitable data that simulates a person's size,body proportions, and the like. The model can be based upon data, for example, used in the clothing and shoe industry to define sizes for apparel and the like. The standard person used and the data set used to derive the standard person is chosen with the user of support device 100 in mind and can be based upon average values of body proportions from any sample of the population from, for example, total population, gender,age, body size or weight, nationality, or the like. The standard person may also be based upon any particular individual, or group of individuals. Thus, the standard person for a particular support device 100 may be designed for marketing to the public in general, or be customized to fit a particular group of people, or to fit an individual.

Turning to FIGS. 3A-3C, a foot 111 is shown inserted into medial depression 106 of support device 100, with the ankle 113 and heel 112 of foot 111 resting on support surface 118 of medial depression 106 between inner side surfaces 114 and 116 of lateral ridges 102 and 104. The foot 111 may face generally upward with toes pointing upward, as shown. However, the foot 111 may be tilted or angled with a side of the foot 111 resting against one of inner side surfaces 114 and 116. Lateral ridges 102 and 104 may be spaced to provide a tight fit or a relaxed fit holding foot 111. Furthermore, medial depression 106 may be spaced with ample wiggle room to the extent that that an ankle need not touch inner side surfaces 114 and 116.

In some embodiments, support surface 118 and/or medial depression 106 may provide adjustments such that the space between may be increased or decreased, as needed. For example, the lateral ridges 102 and 104 may be moved inward and outward along the main body 110 to form a smaller or larger space, respectively. Alternatively, inserts may be added and removed to either or both of inner side surfaces 114 and 116 to change the space of medial depression 106. Appropriate attachments for adjustments may include screws, clamps, straps, and other means commonly known in the art.

Additional materials may be added to provide further support, compression, structure, and weight. For example, cushioning may be added along inner side surfaces 114 and 116 of lateral ridges 102 and 104 to provide a snug or tight fit when a foot 111 is inserted within medial depression 106. Cushioning may be added in select areas along inner side surfaces 114 and 116 of the lateral ridges 102 and 104 that abut sides of the patient's foot, for example, near or at the location where the ankle and heel are to be placed. Alternatively, cushioning may be added on only one side, either inner side surface 114 of the lateral ridge 102 or inner side surface 116 of lateral ridge 104. Again, cushioning may be added in select areas, either at the location or around the location where the ankle and heel are anticipated to be placed or surrounding the location where the ankle and heel are anticipated to be placed. Cushioning may be added with cutaways or surface definitions in the shape of a standard foot, ankle or heel corresponding to various positions anticipated for the foot 111.

FIG. 3B shows an end view of the device in FIG. 3A, with the foot 111 constrained against medial and/or lateral rotation by support device 100. The foot 111 is shown with the heel 112 resting on support surface 118. Also, sides of the ankle 113 are shown in contact with inner side surfaces 114 and 116 of lateral ridges 102 and 104.

FIG. 3C shows an alternate perspective view of FIG. 3A. This view shows the foot 111 and a distal end of a lower limb 115 being supported by support surface 118. The distal end of lower leg 115 is also shown in contact with inner side surfaces 116 and 114. FIGS. 3A and 3C both show only the foot and distal end of a patient's leg being supported in support device 100. The calf is not supported but is suspended by device 100 above a surface on which device 100 rests. This configuration permits the patient's knee (not shown) to remain in a snore extended rather than bent position.

Those skilled in the art will appreciate that supporting heel 112, ankle 113, and lower limb 115 with the support surface 118 and constraining the foot 111 by inner side surfaces 114 and 116 can minimize or prevent medial and/or lateral rotation of the patient's lower leg. With the foot, including ankle and heel, constrained by the device in this manner, it will be appreciated that medial and/or lateral rotational movements of the lower limb and foot can be minimized or prevented. For example, the following movements may be minimized or prevented:
Dorsiflexion: Bending the foot at the ankle toward the shin (bending the foot upward).
Plantar flexion: Bending the foot at the ankle toward the sole (bending the foot downward).
Eversion: Turning the foot so the sole faces laterally.
Inversion: Turning the foot so the sole faces medially.
Circumduction: Moving a part so that its end follows a circular path (moving the toes in a circular motion without significantly moving the ankle).

In addition to minimizing or preventing movements of the foot, the support device may prevent medial and/or lateral rotational movements of the knee and overall leg that may otherwise be caused by medial and/or lateral rotation of the foot. The leg and knee may thus be protected against torsional effects and torque caused by medial and/or lateral rotation of the foot. Also, the foot and knee may be restrained from turning medially (inwardly) or laterally (outwardly), ensuring that the knee does not face a direction other than a direction that is parallel to the direction of the foot. Further, the device supports the foot and ankle such that free space is created proximally to the ankle in the region of the Achilles tendon and calf muscle. This free space allows the leg to drop into full extension at the knee without raising the heel away from the device.

In preventing medial and/or lateral rotation, a leg may be forced to remain in a generally fixed position such that ice may be applied to a region of the leg to reduce swelling or ease pain. In providing stabilizing support and isolation, the leg is better able to get proper rest and healing. If the foot or leg require to be moved, for example, to help adjust body position or remove the patient from the table, the device keeps the process simple because it is easy to install and remove.

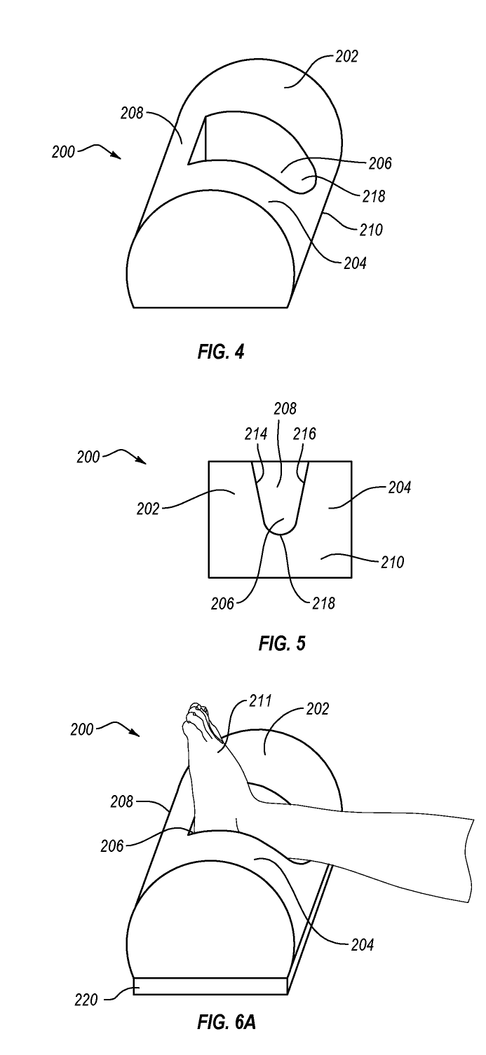

Turning to FIG. 4, a support device 200 for lower limb elevation and stabilization is shown, including a main body 210, lateral ridges 202 and 204, a medial depression 206, a medial ridge 208, and a support surface 218. Medial ridge 208 extending along or near a distal end of medial depression 206 can further support and restrain movement of the patient's ankle and foot. As shown, medial ridge 208 at the medial section may be continuous with lateral ridges 202 and 204 so as to form a continuous medial ridge. Alternatives include, however, that medial ridge 208 not be continuous with lateral ridges 202 and 204. Medial ridge 208 may have a similar width corresponding to widths of lateral ridges. Alternatively, the width of medial ridge 208 may vary. Medial ridge 208 may have a similar height as shown; however, the heights may differ.

Turning to FIG. 5, support device 200 is shown with lateral ridges 202 and 204 having angled inner side surfaces 214 and 216 on opposing sides. Inner side surfaces 214 and 216 are shown to taper downward and toward the center of the device 200. Alternatively, inner side surfaces 214 and 216 can be rounded or vertical. With vertical inner side surfaces and a flat surface, a box-like shape may be present.

As shown, support surface 218 of medial depression 206 may be curved, with the curvature facing upward and joining angled inner side surfaces 214 and 216. Alternatives include a flat support surface 218 that joins the angled inner side surfaces 214 and 216.

Support surface 218 as well as other surfaces of main body 210 may be smooth, pebbled, rough, textured, contoured, or have other features that improve and aid the user experience. For example, a textured surface may improve foot grip and thus further prevent movement.

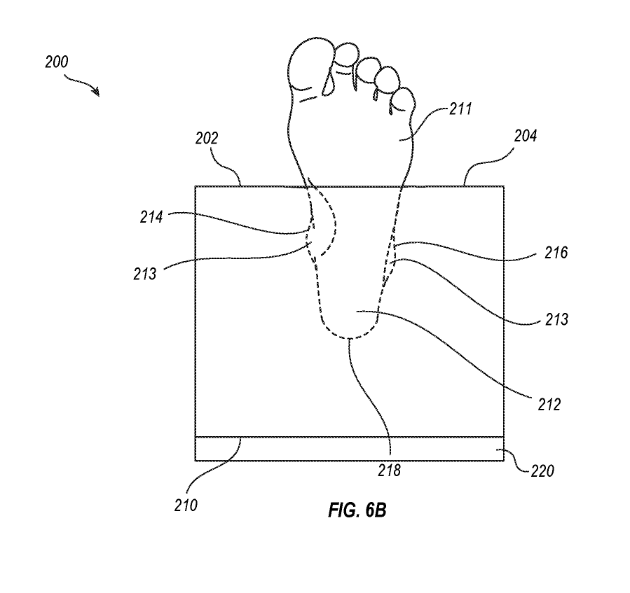

Turning to FIGS. 6A-6C, a foot 211 is shown inserted into device 200. With the addition of medial ridge 208, the foot 211 is prevented from making movements such as plantar flexion movements. By further restraining the foot 211, the addition of medial ridge 208 may help further prevent medial and/or lateral rotation of the lower leg to better protect the knee joint. Medial ridge 208 may also aid the patient in inserting the foot 211 and removing the foot 211 from the device.

FIG. 6B shows an end view of the device of FIG. 6A looking through medial ridge 208, with the foot 211 constrained by device 200, including medial ridge 208. The foot 211 is shown with the heel 212 and lower surface of ankle 213 resting on support surface 218. Also, the sides of ankle 213 are shown in contact with inner side surfaces 214 and 216 of lateral ridges 202 and 204.

Many different materials can be used to manufacture the device. For example, the main body may comprise open cell polymer foam. Embodiments include that the polymer foam be coated with a flexible, fluid-impermeable polymer coating. Alternatives include that the device comprise radiolucent material.

With a given material, the main body may have a height and/or flexibility, coupled with sufficient firmness, so as to maintain a minimum elevation of the patient's ankle of one inch, from the upper surface of the supporting surface, during use. Providing stabilized elevation may be helpful in keeping the leg immobilized at a desired height during a period of medical recovery. Embodiments include that the main body have a firmness with sufficient yield to reduce pressure at and provide a comfortable support for high-pressure, soft-tissue areas.

Furthermore, the device may include an auxiliary pad configured to be positioned directly beneath the main body to further elevate the patient's ankle during use.

In using the device to elevate the patient's ankle during medical recovery, a stable platform, such as a bed or hospital bed, may be provided. The device may be placed on an upper surface of the stable platform. Proper positioning of the device may include putting the device underneath the ankle region of the patient, thereby elevating the ankle of the patient.

The present disclosure may be embodied in other specific forms without departing from its spirit or characteristics. The described embodiments are to be considered as illustrative and not restrictive. The scope of the disclosure is, therefore, indicated by the appended claims rather than by the foregoing description. Changes that come within the meaning and range of equivalency of the claims are to be embraced within their scope.

What is claimed is:

1. A device for supporting and elevating an ankle and heel and restraining medial and lateral rotation of a patient's foot, comprising:
a main body having a generally flat bottom surface;
two spaced-apart lateral ridges extending along or near lateral edges of the generally flat main body; and
a medial depression between the lateral ridges that provides a support surface on which the ankle and heel may be positioned and supported,
wherein the lateral ridges provide inner side surfaces configured to confine and restrain a foot placed therein to limit or prevent medial and lateral rotation of the foot,
wherein the main body terminates proximal to the ankle and/or a distal end of the lower leg so as to not support a calf muscle of the lower leg during use.

2. A device as in claim 1, further comprising a ridge extending along or near a distal end of the medial depression distal to a heel of the foot and provide a surface which prevents plantar flexion of the foot.

3. A device as in claim 2, wherein the ridge is continuous with the lateral ridges so as to form one continuous ridge.

4. A device as in claim 1, wherein the support surface is curved.

5. A device as in claim 1, wherein the support surface is generally flat.

6. A device as in claim 1, wherein at least a portion of a proximal upper surface of one of the spaced-apart lateral ridges has a downwardly curving slope declining from an upper extent of the lateral ridge towards a lower extent of the lateral ridge at a proximal end of the device such that the lateral ridge at least partially forms a curved shape.

7. A device as in claim 1, wherein at least a portion of a distal upper surface of one of the spaced-apart lateral ridges has a downwardly curving slope declining from an upper extent of the lateral ridge towards a lower extent of the lateral ridge at a distal end of the device such that the lateral ridge at least partially forms a curved shape.

8. A device as in claim 1, wherein the main body comprises open cell polymer foam.

9. A device as in claim 8, wherein the polymer foam is coated with a flexible, fluid-impermeable polymer coating.

10. A device as in claim 1, wherein the device comprises radiolucent material.

11. A device as in claim 1, wherein the main body is configured to maintain, during use, a minimum elevation of the patient's ankle of at least one inch from a platform or surface supporting the device.

12. A device as in claim 1, wherein the main body has a firmness with sufficient yield to reduce pressure at and provide a comfortable support for high-pressure, soft-tissue areas.

13. A device as in claim 1, wherein the medial depression is contoured to approximately fit the contour of one or more of the lower leg, heel, ankle region, and talus of the patient.

14. A device as in claim 1, further comprising an auxiliary pad configured to be positioned directly beneath the main body to further elevate the patient's ankle during use.

15. A device for supporting and elevating an ankle and heel and restraining medial and lateral rotation of a patient's foot, comprising:
a main body having a generally flat bottom surface;
two spaced-apart lateral ridges extending along or near lateral edges of the generally flat main body; and
a medial depression between the lateral ridges that provides a support surface on which the ankle and heel may be positioned and supported,
wherein the lateral ridges provide inner side surfaces configured to confine and restrain a foot placed therein to limit or prevent medial and lateral rotation of the foot,
wherein the main body terminates proximal to the ankle and/or a distal end of the lower leg so as to not contact a calf muscle of the lower leg during use,
wherein the main body is configured to maintain a minimum elevation of the patient's ankle of at least one inch above a platform or surface supporting the device.

16. A device as in claim 15, further comprising a medial ridge extending along or near a distal end of the medial depression distal to a heel of the foot and provide a surface which prevents plantar flexion of the foot.

17. A device as in claim 16, wherein the medial ridge is continuous with the lateral ridges so as to form one continuous ridge.

18. A method for elevating and restraining a patient's ankle during a recuperative period, such as would be expected following a surgical procedure or injury, comprising:
providing a stable, relatively flat platform;
placing the device of claim 1 on an upper surface of said platform;
positioning the device underneath the ankle region of the patient, thereby elevating the ankle of the patient; and
limiting or preventing ankle and leg rotation to protect a knee of the patient.

19. A method as in claim 18, wherein the platform comprises a surgical table or bed.

20. A method as in claim 19, wherein the device does not support or elevate the patient's calf muscle.
